(19) United States
(12) Patent Application Publication
(10) Pub. No.: US 2003/0197307 A1
(43) Pub. Date: Oct. 23, 2003

(54) Method for the injection molding and successive decoration molding for a molded product

(76) Inventors: Akihiro Kitamura, Osaka (JP); Nobuo Iijima, Osaka (JP); Yoshihiko Saitou, Osaka (JP); Haruo Okada, Nagano-ken (JP); Toru Ikeda, Nagano-ken (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/388,319

(22) Filed: Mar. 13, 2003

(30) Foreign Application Priority Data
Mar. 14, 2002 (JP) 2002-070902

(51) Int. Cl. B29C 45/00

(52) U.S. Cl. 264/255; 264/328.8

(57) ABSTRACT

Injection molding of a product and decoration molding of a surface of the molded product are performed using individual cavity molds. A decorative film can be molded efficiently with a thermosetting coating material under suitable temperature control regardless of the shape of the molded product. An injection cavity mold and a decoration cavity mold are employed. The injection cavity mold is set at a hardening temperature of a thermoplastic resin. The decoration cavity mold is set at a thermosetting temperature of a coating material. A molded product is formed by injection molding in the injection cavity mold. The injection molded product is located within the decoration cavity mold to create a space as a cavity for decoration molding between an inner surface of the decoration cavity mold and a surface of the injection molded product. A decorative film is molded over the surface of the injection molded product by injecting a decorative coating material composed of a liquid thermosetting composition into the cavity under pressure. The coating material is composed of a liquid thermosetting composition that substantially contains no volatile component having a boiling point below the thermosetting temperature set on the cavity mold for decoration molding.

### BACKGROUND OF THE INVENTION

1. Field of the Invention

The present invention relates to a method of injection molding of a molded product using a synthetic thermoplastic resin, and successive decoration molding of a decorative film over a surface of the molded product using a coating material in cavity molds respectively.

2. Description of the Related Art

In a method so-called In-Mold Coat Molding, a decorative film of a coating material is molded over a surface of a molded product of a synthetic resin. In this method, a cavity mold for the injection molding is also used as that for the decoration molding.

For example, JP 2001-38783A discloses a conventional molding method, which comprises providing an injection cavity mold and a core to form a cavity for a molded product; injecting a melted resin fully into the cavity to form the molded product; moving the core slightly backward to form a desired space between the surface of the molded product and the surface of the cavity; and injecting a decorative coating material into the space to form a decorative film.

In such the conventional molding method that employs the injection cavity mold commonly in two types of molding for the molded product and the decorative film, the cavity mold and the core are set at a hardening temperature of a thermoplastic resin for injection molding of the product. Therefore, if the coating material is composed of a thermoplastic composition, there is no difficulty in temperature control of the cavity mold. To the contrary, if the coating material is composed of a thermosetting composition, it is required to elevate the temperature in the cavity mold up to a thermosetting temperature of the coating material in a short time after the injection molding.

The hardening temperature of the thermoplastic resin set on the cavity mold and the core has a difference from the thermosetting temperature of the coating material. This temperature difference varies depending on the material resin of the molded product and the substrate of the coating material though it has a value of at least 30° C. or more. It is considered technically difficult to elevation control such the temperature difference in a limited molding time. Therefore, the conventional molding method that employs the injection cavity mold commonly for the two types of molding has a problem because it is hardly utilized in decoration molding using a thermosetting coating material.

The space for molding the decorative film is formed in retreating operation of a movable table that carries the core attached thereon or a moving device located inside the table. Therefore, the formation of the space requires a sophisticated positioning control and a means for retaining the space. In addition, the formation of the space by the retreat of the core is limited in between opposing surfaces: a front surface of the molded product and a surface of the cavity. In this case, vertical sides of the product are in parallel with the moving direction of the core and keep in contact with the cavity surface without forming any space therebetween. Therefore, it is impossible to mold a decorative film over vertical sides of a box-like molded product, resulting in a problem because the decoration molding is restricted in products molded in limited shapes.

The formation of the space by the retreat of the core also makes a space between parting faces. Therefore, it is impossible to form a gate for injecting a coating material in between the parting faces to employ it as a side gate for injecting the coating material through an opening edge of the molded product. Thus, injection is performed inevitably through a gate designed at the top center, resulting in a gate trace in the top of the product. The gate trace often causes an outer design defect depending on the product. It is also required to prevent the coating material from flowing out to the parting face. This need causes a problem because a mold structure is complicated.

The present invention has been devised to solve the problems in the conventional methods and accordingly has an object to provide a new method of injection molding a molded product and successive decoration molding for the molded product. This method employs individual cavity molds for injection molding a molded product and decoration molding a surface of the molded product. It is capable of efficiently molding a decorative film with a thermosetting coating material under suitable temperature control, without application of special anti-outflow measures, regardless of the shapes of injection molded products.

### SUMMARY OF THE INVENTION

In accordance with the above object, the present invention is directed to a method of injection molding a molded product and successive decoration molding of a decoration film over a surface of the molded product, which comprises providing a cavity mold for injection molding and a cavity mold for decoration molding; setting the cavity mold for injection molding at a hardening temperature of a thermoplastic resin and the cavity mold for decoration molding at a thermosetting temperature of a coating material; injection molding a molded product in the cavity mold for injection molding; locating the injection molded product within the cavity mold for decoration molding to create a space to be used as a cavity for decoration molding between an inner surface of the cavity mold for decoration molding and a surface of the injection molded product; and decoration molding a decorative film over the surface of the injection molded product by injecting a decorative coating material composed of a liquid thermosetting composition into the cavity under pressure. The coating material may be composed of a liquid thermosetting composition substantially containing no volatile component having a boiling point below, the thermosetting temperature set on the cavity mold for decoration molding.

In the above arrangement, the phrase “substantially containing no volatile component” means that, even if a volatile component is contained in the liquid thermosetting composition, the volatile component is allowed to have a content within a range that causes no problem in the step of molding the decorative film. For example, the volatile component may be contained if the content is below 5% by weight, preferably below 3% by weight, because such the content can not break the purpose of the present invention.

In the present invention, the thermosetting temperature set on the cavity mold for decoration molding is contained within a range of from 80° C. to 140° C., preferably from 110° C. to 140° C. In this case, the coating material has a viscosity of 3,000-100,000 mPa's, preferably 7,000-30,000 mPa's. The viscosity is measured by coaxial bi-cylindrical rotational viscometer (B-type viscometer) in conformity with JIS K5600-2-3 (1999) under condition at 25° C., 6 rpm.

In the present invention, the method may further comprise providing a core shared by the cavity mold for injection molding and the cavity mold for decoration molding; and moving the two cavity molds relative to the core or moving the core relative to the two cavity molds after the injection molding and prior to the decoration molding.

In the above arrangement, the injection molding of the molded product and the decoration molding of the decorative film are performed in individual cavity molds and temperatures suitable for their molding. Therefore, it is possible to perform both moldings under proper temperature control to easily mold the decorative film of the thermosetting coating material over the surface of the molded product. The cavity for molding the decorative film is formed between the cavity mold for decoration molding and the core by closing molds. Therefore, it is possible to form and retain a cavity with a space having a designed size without the need for a sophisticated positioning control of a movable table. The cavity is not limited in between opposing surfaces: the front surface of the molded product and the surface of the cavity. For example, it may be formed along the top and vertical sides of the molded product. Therefore, an injection gate and a gas vent of the cavity can be located in the parting face to mold the decorative film over vertical sides of a box-like molded product in addition to the top thereof with no special anti-outflow measures. As a result, a product with nice molding precision can be manufactured without suffering any restriction in shapes.

Temperatures on both cavity molds, for injection molding and decoration molding, can be set individually. Therefore, it is always possible under suitable temperature control to injection mold a thermoplastic resin material to form a molded product and decoration mold a thermosetting resin coating material to form a decorative film. In addition, the temperature control of the cavity mold for decoration molding can be divided into plural systems to even the thermosetting of the coating material. Therefore, it is also possible to manufacture a product having a high gloss surface and excellent in decorated conditions such as adhesion, weather resistance and mar resistance independent of a thickness of the decorative film.

### BRIEF DESCRIPTION OF THE DRAWINGS

The present invention will be more fully understood from the following detailed description with reference to the accompanying drawings, in which:

FIG. 1 is a horizontal-sectional view showing molds for injection molding to form a molded product and successive decoration molding to form a decoration film over a surface of the molded product according to the present invention, which shows the injection molded product;

FIG. 2 is a horizontal-sectional view showing the molded product replaced into a decoration cavity mold;

FIG. 3 is a horizontal-sectional view showing a state before press-injection of a coating material and a state of a decorative film molded in the decoration cavity mold;

FIG. 4 is a plan cross-sectional view showing a state of opening mold;

FIG. 5 is a perspective view of a product according to the present invention, from which the decorative film is partly cut off;

FIG. 6 is a horizontal-sectional view showing molds in another embodiment that rotates a pair of core molds to replace one with another; and

FIG. 7 is a plan cross-sectional view showing an injection molded product and a decoration molded film.

### DETAILED DESCRIPTION OF THE PREFERRED EMBODIMENTS

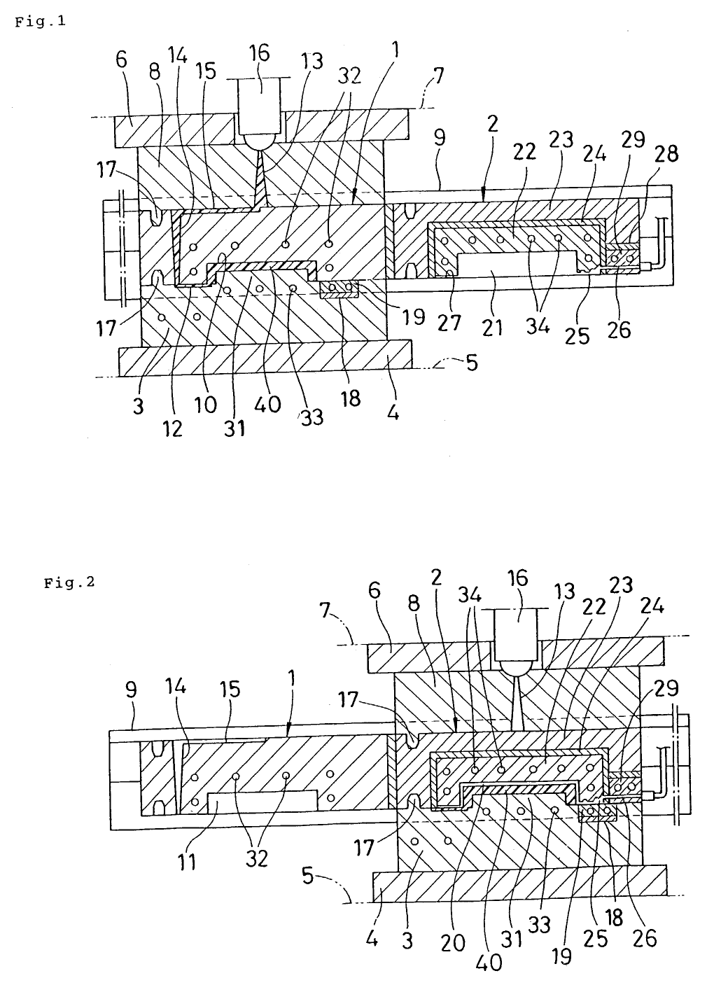

FIGS. 1-4 show an embodiment to slide an injection cavity mold 1 and a decoration cavity mold 2 relative to a core mold 3, for injection molding of a product 40 using a synthetic thermoplastic resin, and for decoration molding of a decorative film 41 over a surface of the molded product as shown in FIG. 5.

As shown in FIGS. 1 and 2, the injection cavity mold 1 and the decoration cavity mold 2 can be replaced with each other about the core mold 3, which is attached to the inner surface of a movable table 5 using a mold attachment plate 4, and a runner mold 8, which is attached to a stationary table 7 using a mold attachment plate 6. For this purpose, the molds 1 and 2 are arranged in parallel and slidably in the longitudinal direction by means of guide rails or grooves, not shown, on the upper surface of a sliding base 9 that is laterally elongated and located beneath them. The sliding base 9 is connected to the stationary table and the movable table like in a general three-plate mold so that it can move in the direction of opening/closing mold, these specific structures are not shown in the figures. After opening mold, the injection cavity mold 1 and the decoration cavity mold 2 are slid laterally for facing the core mold 3 by a moving device, not shown.

The injection cavity mold 1 has a recess 11 in its parting face facing the core mold 3. The recess 11 and a core 31 at the center of the core mold form a cavity 10 for the molded product 40 in the form of a box consisting of a top plate and four vertical side plates. A side gate 12 is formed in between a parting face outside the recess 11 and a parting face of the core mold 3. In a parting face of the mold 1 that faces the runner mold 8, a runner 15 is formed for connecting a sprue 13, which is bored at the center of the runner mold 8, to a passage 14, which is bored in the injection cavity mold 1 and connected to the side gate 12. The reference numeral 16 denotes an injection nozzle and 17 a positioning pin.

The decoration cavity mold 2 includes a mold member 22 that has a recess 21 in a parting face to form a cavity 20 for decoration when it receives the molded product 40 together with the core 31; a mold body 23 that houses the mold member 22 fitted in a parting face facing the core mold 3; and a heat insulator 24 interposed between the mold body 23 and the mold member 22.

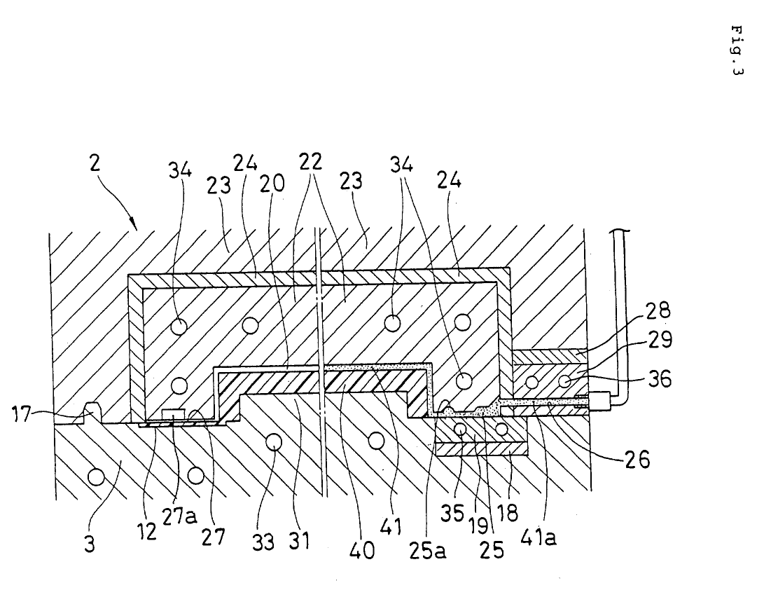

An injection gate 25 for injecting a coating material 41 is formed between a parting face outside the mold member 22 and a parting face of the core mole 3. The injection gate 25 is connected to an injection path 26 formed through the heat insulator 24 from outside the mold body 23 as a side gate that spreads out toward the recess 21 from the injection path 26. A gas vent 27 and a recess 27a are formed on a parting face opposing to the injection gate 25 as shown in FIG. 3.

The parting face of the injection gate 25 at the core mold side and the parting face of the mold body for locating the injection path 26 have temperature control members 19, 29 embedded inside of the parting faces together with heat insulators 18, 28. The injection path 26 is formed through the member 29. The injection gate 25 is narrowed stepwise near the mold body toward the recess from the end connected with the injection path 26 to taper the parting face opposing to the injection path 26. A resin pool 25a for preventing involution of air is formed in the vicinity of the recess 21 to inject the coating material 41a uniformly without interruption (see FIG. 3).

Temperature control paths 32, 33, 34, 35, 36 are formed inside the injection cavity mold 1 and the core mold 3, the mold member 22, and the members 18, 29, respectively. By means of temperature control media supplied into these temperature control paths, the injection cavity mold 1 and the core mold 3 are kept at a hardening temperature of the resin (40° C. to 80° C.). The mold member 22 of the decoration cavity mold 2 and the member 19 for forming the injection gate 25 are kept at a thermosetting temperature of the coating material 41a (80° C. to 140° C.). The member 29 is kept at a temperature that can prevent the thermosetting of the coating material 41a (15° C. to 30° C.).

Heating by a cartridge heater is applicable to the temperature control for the mold member 22 of the decoration cavity mold 2 and the member 19. Preferably, the temperature control for the mold member 22 may be performed in two systems divided into the top and the side to adjust variations in temperature.

Of the injection molding and the decoration molding by the molds, the injection molding of the molded product 40 should be performed first. After the injection cavity mold 1 is located in between the runner mold 8 and the core mold 3, the movable table 5 is advanced for closing mold as shown in FIG. 1. After clamping mold, a melted resin is injected through the injection nozzle 16 and injected fully into the cavity 10 through the runner 15 and the distribution hole 14 from the side gate 12.

Available thermoplastic resins as the material of the molded product 40 include polyolefine, ABS, polycarbonate, polyurethane, polyester, polyamide, ABS, and vinyl chloride.

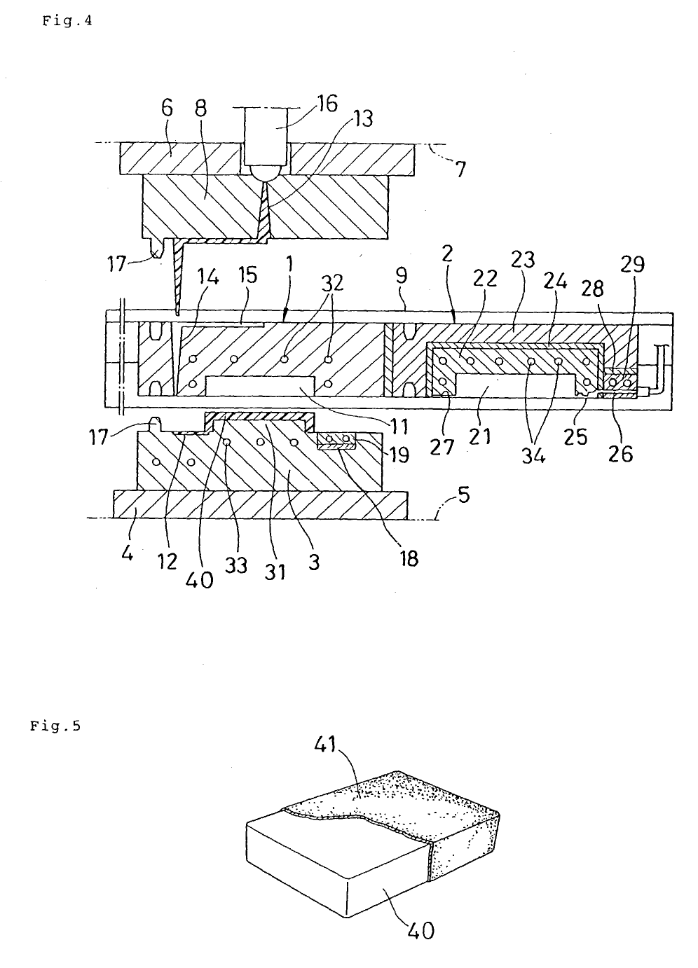

After the resin in the cavity is hardened through cooling under constant pressure, the movable table 5 is moved backward for opening mold. This opening mold is performed as a result of movement of the sliding base 9 because, as shown in FIG. 4, the injection cavity mold 1 separates from the runner mold 8, and the core mold 3 separates from the injection cavity mold 1. According to the opening mold, the molded product 40 fitted around the core 31 by contraction during hardening can be released from the injection cavity mold 1.

After completion of releasing the molded product 40 from the mold, both cavity molds are shifted from the state of FIG., 4 to the left side to replace the decoration cavity mold 2 from the right side to a location between the core mold 3 and the runner mold 8, which are now opened. Thereafter, the movable table 5 is advanced for closing mold as shown in FIG. 2. The closing mold is performed first between the decoration cavity mold 2 and the core mold 3, and then the decoration cavity mold 2 is pushed for closing mold with the runner mold 8.

After closing mold, the molded product 40 together with the core mold 3 enters the recess 21 in the decoration cavity mold 2, remaining a space of a designed size. The space forms the cavity 20 between the molded product 40 and the cavity surfaces facing the top and sides of the molded product 40. Both parting faces of the decoration cavity mold 2 and the core mold 3 form the gas vent 27 at the side opposite to the injection gate 25. The coating material 41a for molding the decorative film 41 can be injected under pressure into the cavity 20 through the injection gate 25. After clamping mold, the coating material 41a is actually injected under pressure from the injection path 26 through the injection gate 25 into the cavity 20.

The space in the cavity 20 can be determined within a range of 50-200 μm depending on the thickness of the decorative film 41 that covers the surface of the molded product. The molded product 40 tends to reduce the thickness on cooling during molding. The thicker the molded product, the more the thickness reduces extremely. Therefore, in the thicker molded product the space in the cavity 20 is determined expecting its variation. In contrast, the thinner the molded product, the smaller the variation in the thickness. Therefore, preferably the space is determined without expectation.

The coating material 41a suffers heating within the cavity. If it has a composition that contains a volatile component with a boiling point below the thermosetting temperature, a problem is easily caused when the volatile component vaporizes. To avoid this problem, the coating material 41a is preferably composed of a liquid thermosetting composition that substantially contains no volatile component with a boiling point below the thermosetting temperature set on the decoration cavity mold. A preferable composition may be mixed at least with agents excellent in properties of adhesion with the material, durability, viscosity adjustment, crosslinking initiation, decoration, and antifoaming. For example, when a polypropylene resin is employed as the material of the molded product 40, a composition suitable for the coating material 41a may be mixed with acrylic modified polyolefine, reactive oligomer, reactive diluent, radical polymerization initiator, aluminum powder, and other additives.

Preferably, the coating material 41a has a viscosity of 3,000-100,000 mpa's, more preferably 7,000-30,000 mPa's The viscosity is appropriately selected based on the space size and flow length in the cavity 20 and the cavity temperature. Its injection is performed under pressure about 55 kgf.

The coating material 41a, injected into the parting portion in the cavity 20 through the injection gate 25, flows from one vertical side of the molded product 40 to the top and both other sides and finally reaches the opposite side. The coating material 41a is thermosetted while it flows inside the heated cavity, beginning from the cavity-surface side. If it takes a long time to complete the injection, the thermosetting of the coating material 41a advances from the cavity-surface side before completion of the injection, forming weld and causing mottle due to unevenness in a decorative agent such as aluminum powder. Therefore, it is desirable to complete the injection as fast as possible, for example, within two seconds. If a relatively long injection time is required, it is preferable to set the thermosetting temperature low to suppress the thermosetting at the cavity-surface side and reduce differences in thermosetting time in the direction of the film thickness.

In the cavity 20, the thermosetting time in the vicinity of the injection gate differs from that at the flow end on the opposite side, for example, at the temperature set to 120 ° C., it takes about 5-10 seconds at the flow end and about 20-30 seconds in the vicinity of the injection gate. However, it causes no defects in the decorative film 41 on the surface of the molded product.

After the thermosetting time is elapsed, the movable table 5 is moved backward for opening mold between the decoration cavity mold 2 and the core mold 3. Subsequently, though it is not shown in the figure, the product fitted around the core 31 and having the decorative film 41 molded over the surface is released from the core mold. The injection gate 25 is also heated from both the mold member 22 and the core mold 3 and the coating material 41a resided at the heated portion is thermally hardened. The mold releasing can remove the residual hardened matter, from the portion connected with the injection path 26 to the parting face of the core mold 3, together with the molded product 40 fitted around the core 31 and having the decorated surface.

After the mold releasing, both cavity molds are slid to the right side for the injection cavity mold 1 being positioned between the core mold 31 and the runner mold 8. Thereafter the replacement, the movable table 5 is moved forward for closing and clamping mold again as shown in FIG. 1, and the step is shifted to the next injection molding of a new molded product.

As described above, to mold the product and to mold the decorative film over the surface of the molded product, this method employs two cavity molds: the injection cavity mold and the decoration cavity mold. This method differs from the case in which a single cavity mold is employed commonly for injection molding of a molded product and molding of a decorative film. Suffering no limitations within the scope of variation in injection moldable shapes of molded products to be subjected to decoration molding of decoration films, this method can mold the decorative film uniformly over the vertical sides of the molded product in addition to the top thereof.

The temperatures on both cavity molds can be set individually. Therefore, under suitable temperature control, it is always capable of injection molding a thermoplastic resin material to form a molded product and decoration molding a thermosetting coating material to form a decorative film. In addition, the temperature control of the decoration cavity mold can be divided into plural systems to even the thermosetting of the coating material. Therefore, it is also possible to mold a product excellent in molding accuracy and decoration without being affected by the thickness of the decorative film.

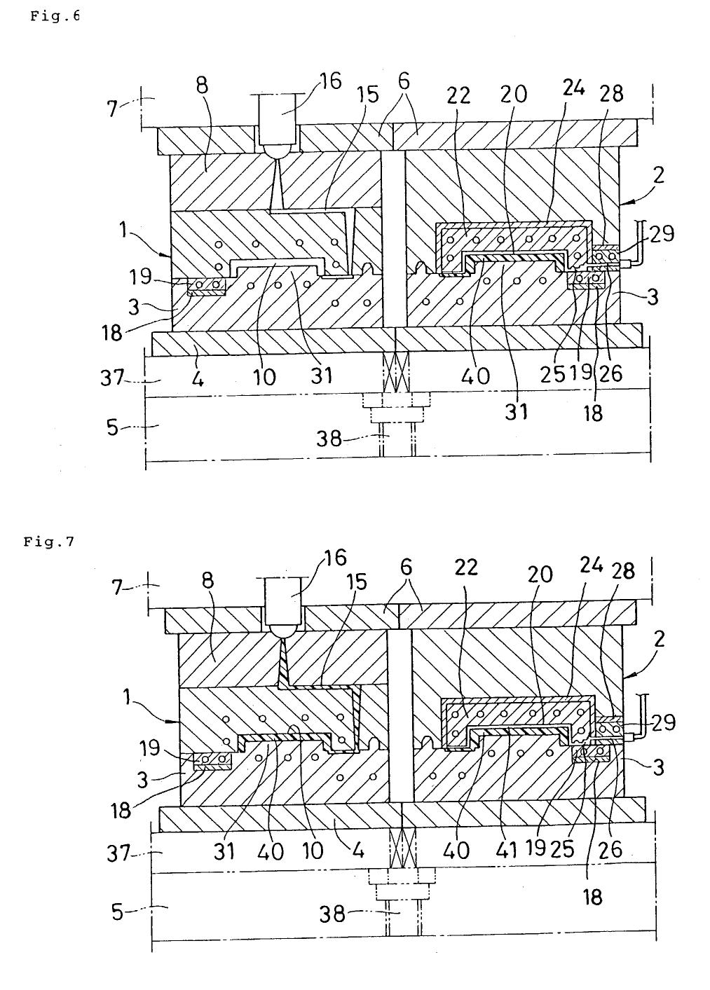

FIGS. 6 and 7 show another embodiment to rotate core molds 3 relative to an injection cavity mold 1 and a decoration cavity mold 2, for injection molding of a product 40 using a synthetic thermoplastic resin as a raw material, and for decoration molding of a decorative film 41 over a surface of the molded product as shown in FIG. 5. The same parts as those in the previous embodiment are omitted for explanation, and the major parts are explained with the reference numerals attached thereto.

In this embodiment, like a general two-color molding, the injection cavity mold 1 and the decoration cavity mold 2 are arranged at symmetric positions on the stationary table. A pair of core molds 3, 3 are attached on a rotary plate 37 provided on the inner surface of the movable table 5 and located at the positions opposing to the molds. The rotary plate 37 can be rotated reciprocally about a rotary shaft 38 coupled to the center in the movable table to switch the core molds 3, 3. In this case, if the runner 15 is a hot runner, the mold releasing of the runner after opening mold can be omitted.

Replacement of the core molds 3, 3, though it is not shown in the figure, can be performed by: injection molding of the product 40 and decoration molding of the decorative film 41; after completion of both, retreating the movable table 5 for closing mold of the core molds 3, 3; then rotating the rotary plate 37 by 180° and stopping it; thereafter releasing the completed product from the mold; and advancing the movable table 5 for closing mold. After the closing mold, a cavity 10 for the molded product 40 is formed between the injection cavity mold 1 and the core 31. A cavity 20 for molding the decorative film 41 is formed as a space between the cavity surface and the molded product surface at the decoration cavity mold 2 that houses the molded product 40 together with the core 31 like the previously described embodiment.

After the closing mold, both cavity molds are clamped, then the product 40 is injection molded and the decorative film 41 is molded over the product surface. After completion of the molding, the molds are opened and the completed product is released from the mold. Thereafter, the rotary plate 37 is rotated by 180° in the reverse direction to switch the positions of the core molds 3, 3. The movable table 5 is then moved forward for closing mold again and shifting the work to the next.

Thus, the pair of core molds 3, 3 are rotated and alternately switched to the injection cavity mold 1 and the decoration cavity mold 2 that are arrayed in parallel. This method can mold the product 40 and the decorative film 41 at the same time. Therefore, it has a higher molding efficiency suitable for mass production compared to the above-described method in which the injection cavity mold 1 and the decoration cavity mold 2 are slid and switched alternately to the core mold 3.

### EXAMPLE

| | |
|---|---|
| Material of Molded product: | Polypropylene |
| Shape of Molded product: | Box type, 150 wide × |
| | 210 deep × 20 mm high |
| Thickness of Molded product: | 2.5 mm |
| Coating material: | KX-1031A (Silver metallic), |
| | Trade name of Nippon Bee |
| | Chemical Co., Ltd. JAPAN |
| Viscosity: | 10,000 mPa's at 25° C., |
| | 6 rpm Measured by B-type |
| | viscometer made by |
| | TOKIMEC INC. JAPAN |
| Thickness of Decorative film: | 100 μm |
| Molding machine used: | ES3000-25E |
| | (Mold slide replacement |
| | Trade name of Nissei Plastic |
| | Industrial Co., Ltd. |
| Temperature in Injection cavity mold: | 80° C. |
| Temperature in Core mold: | 80° C. |
| Clamping mold force (Injection molding): | 126 tonf |
| Molding time: | 60 sec |
| Space set in Decoration cavity mold: | 100 μm |
| Gate space in Injection inlet: | 100 μm |
| Resin pool: | 2.0 μm |
| Gate width of Injection inlet: | 160 μm |
| Gas vent: | 10 μm |
| Temperature in Decoration cavity: | 120° C. |
| Temperature in Injection inlet: | 120° C. |
| Temperature in Injection path: | 30° C. |
| Clamping mold force (Decoration): | 17.5 tonf |
| Injection pressure: | 55 kgf |
| Injection time: | 1.4 ± 0.1 sec |
| Thermosetting time: | 60 sec |

| | |
|---|---|
| Gloss (Reflectivity at 60 degrees) | 91 |
| FF value (Flip-Flop): | 1.5 |
| Initial adhesion (2 mm cross-cut): | 100/100 |
| Secondary adhesion after water resistance test: | 100/100 |
| Weather resistance (SWOM 1000 H) GR: | 91 |
| ΔE: | 2.0 |
| Mar resistance: | Passed |

(Mar resistance test: 8 sheets of gauze are putted on a test piece, and a weight of 500 g is putted on gauze in an rubbing tester, which reciprocates it 100 times and determines that the test piece is passed if it is not damaged on its appearance)

Having described the embodiments consistent with the invention, other embodiments and variations consistent with the invention will be apparent to those skilled in the art. Therefore, the invention should not be viewed as limited to the disclosed embodiments but rather should be viewed as limited only by the spirit and scope of the appended claims.

What is claimed is:

1. A method of injection molding and successive decoration molding a molded product, comprising:
providing a cavity mold for injection molding and a cavity mold for decoration molding;
setting said cavity mold for injection molding at a hardening temperature of a thermoplastic resin and said cavity mold for decoration molding at a thermosetting temperature of a coating material;
injection molding a molded product in said cavity mold for injection molding;
locating said injection molded product within said cavity mold for decoration molding to create a space to be used as a cavity for decoration molding between an inner surface of said cavity mold for decoration molding and a surface of said injection molded product; and
decoration molding a decorative film over said surface of said injection molded product by injecting a decorative coating material composed of a liquid thermosetting composition into said cavity under pressure.

2. The method of claim 1, wherein said coating material is composed of a liquid thermosetting composition substantially containing no volatile component having a boiling point below said thermosetting temperature set on said cavity mold for decoration molding.

3. The method of claim 1, wherein said thermosetting temperature set on said cavity mold for decoration molding is contained within a range of from 80° C. to 140° C., said coating material having a viscosity of 3,000-100,000 mPa's.

4. The method of claim 1, 2 or 3, further comprising:
providing a core shared by said cavity mold for injection molding and said cavity mold for decoration molding; and
moving said two cavity molds relative to said core or moving said core relative to said two cavity molds after said injection molding and prior to said decoration molding.
